(19) United States
(12) Patent Application Publication
(10) Pub. No.: US 2025/0309713 A1
(43) Pub. Date: Oct. 2, 2025

(54) ROTOR FOR AN EXTERNAL ROTOR MOTOR

(71) Applicant: BorgWarner Inc., Auburn Hills, MI (US)

(72) Inventors: Silvio Koch, Kirchheimbolanden (DE); Benedikt Hummel, Zweibrücken (DE); Thomas Ramb, Worms (DE)

(21) Appl. No.: 19/086,874

(22) Filed: Mar. 21, 2025

(30) Foreign Application Priority Data
Mar. 28, 2024 (DE) 10 2024 108 918.0

(51) Int. Cl. H02K 1/30; H02K 1/2791

(52) U.S. Cl. CPC H02K 1/30; H02K 1/2791

(57) ABSTRACT

A rotor for an external rotor motor is described that has an annular stack of steel sheets welded together, permanent magnets, which are attached to an inner face of the stack, a carrier which has a hub for a shaft, and brackets, which engage around a radially outer edge of the carrier, and press the carrier against the stack in the axial direction. In accordance with this disclosure, the stack has pressure application surfaces between its axial ends, against which presses one end of the brackets facing away from the hub.

### RELATED APPLICATIONS

This application claims priority to DE 10 2024 108 918.0, filed Mar. 28, 2024, the entire disclosure of which is hereby incorporated herein by reference.

### BACKGROUND AND SUMMARY

This disclosure relates to a rotor for an external rotor motor having an annular steel sheet stack, permanent magnets, which are fixed to an inner face of the sheet stack, and a carrier, which has a hub for a shaft, and is fixed to the sheet stack.

This disclosure shows a way in which the carrier of a rotor for an external rotor motor can be attached to the sheet metal stack in a cost-effective manner.

In a rotor of this disclosure, the stack of steel sheets that are welded together is pressed against the carrier in the axial direction by brackets that abut against an outer face of the stack. The stack has pressure application surfaces between its axial ends, against which presses an end of the brackets facing away from the carrier. Brackets that are significantly shorter than the axial length of the sheet stack can therefore be used advantageously. The brackets of a rotor in accordance with this disclosure are therefore inexpensive and enable simple production. Each of the brackets of a rotor in accordance with this disclosure can be produced cost-effectively from sheet metal as a stamped and bent part.

The pressure application surfaces of the sheet stack, against which the brackets press, are preferably formed by radial projections of the sheet stack, but can also be formed by recesses and indentations on the outer face of the sheet stack.

In an advantageous refinement of this disclosure, provision is made for the sheet stack to be constructed from metal sheets of the same cut. For example, the annular metal sheets can have radial projections, for example, 3 to 6 projections, on their outer circumference. If a group of such sheets, for example, 4 to 6 sheets, are stacked against each other at the same angle of rotation, the result is a small sheet stack with, on its outer face, radial projections that each extend in a straight line in the axial direction. A second stack consisting of a second group of sheets can then be placed on top of this small stack, all of which are offset from the sheets in the first group by a predetermined angle of rotation. Although all the sheets in the stack formed in this way are identical, a stack can be created which has pressure application surfaces on the boundary between the first and second groups, to which the brackets can attach.

In a further advantageous refinement of this disclosure, provision is made for the pressure application surfaces to be formed by axial end surfaces of radial projections of the sheet stack. These projections are preferably undercut on lateral surfaces extending in the axial direction, and the brackets engage with these undercuts. Such an undercut can, for example, be designed as a groove extending in the axial direction in a side surface of a projection. In this way, unintentional loosening of the brackets can be made more difficult.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows an embodiment of a rotor in accordance with this disclosure;

FIG. 2 shows a view of the sheet metal stack of the rotor;

FIG. 3 shows a detail of the rotor;

FIG. 4 shows a cross-sectional detail of the rotor;

FIG. 5 shows a further cross-sectional detail of the rotor; and

FIG. 6 shows a view of a bracket of the rotor.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

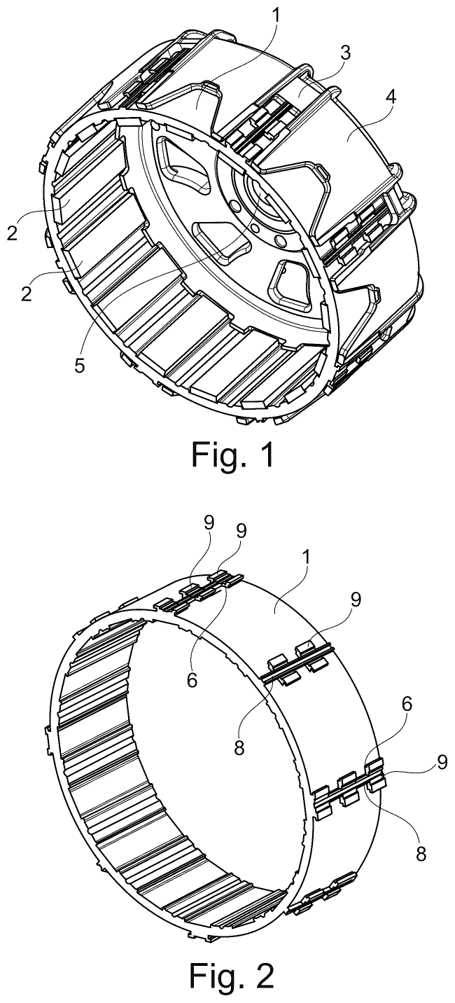

FIG. 1 shows a rotor of an electric motor, more specifically, an external rotor motor. The rotor comprises an annular stack of sheets 1 made of ferromagnetic steel, for example, of electrical steel sheet, or another soft magnetic steel sheet. The individual sheets of the sheet stack 1 may be annular sheets or only segments of a circle. Permanent magnets 2 are attached to the inner face of the sheet stack 1. The permanent magnet may, for example, be based on Nd₂Fe₁₄B. The permanent magnets 2 may, for example, be arranged in grooves of the sheet stack 1, and fixed in position by means of adhesive. The sheet stack 1 is attached with brackets 3 to a carrier 4, which comprises a hub 5 for insertion of a shaft. The brackets 3 grip around a radially outer edge of the carrier 4 and press the carrier 4 against the stack 1 in the axial direction.

FIG. 2 shows the sheet metal stack 1 of the rotor. The sheets of the stack 1 are welded together. Between its axial ends, the sheet stack 1 has radial projections 9 on its outer face, which form pressure application surfaces 6. These pressure application surfaces are engaged by the brackets 3. An end of the brackets 3, which faces away from the hub 5 presses against such a pressure application surface 6.

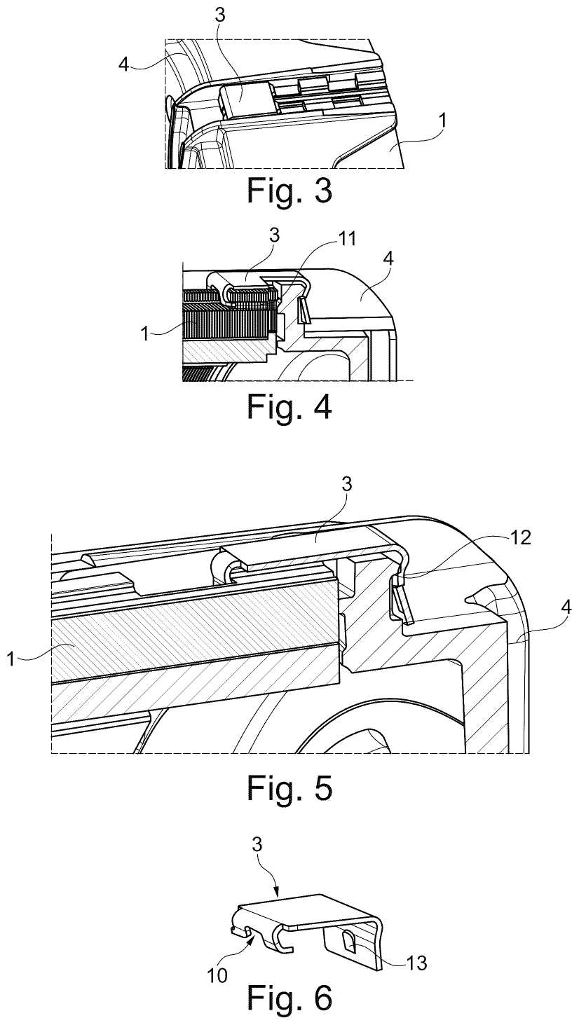

FIG. 3 shows a detail of the rotor, FIG. 4 shows a cross-sectional detail of the rotor, where the plane of the cross-section extends along the edge of a bracket 3. FIG. 5 shows a further cross-sectional detail of the rotor, where the plane of the cross-section runs through the centre of one of the brackets 3. FIG. 6 shows one of the brackets 3.

The pressure application surfaces 6 are formed as axial surfaces of radial projections 9 of the sheet stack 1. As shown in particular by FIG. 4, these projections 9 are undercut in their lateral surfaces extending in the axial direction. In other words, the projections 9 have an undercut 11, or a recess, in their lateral surfaces, for example, a groove extending in the axial direction. The brackets 3 engage with this undercut 11. In this way, any undesirable loosening of the brackets 3, in particular as a result of radial forces, is made more difficult. Alternatively or additionally, the brackets 3 can also be materially bonded to the sheet stack 1, for example, by means of welding or an adhesive.

The projections 9, which form the pressure application surfaces 6, can project laterally from ribs 8, which extend linearly in the axial direction. As shown in particular by FIG. 2, the sheet stack 1 has a plurality of ribs 8 on its outer face; these extend over the entire length of the sheet stack. The pressure application surfaces 6 extend in the circumferential direction from both sides of some of these ribs 8; in the example shown, this is from every second rib 8. On their end section the brackets 3 have a slot 10, which presses against the pressure application surfaces 6; the rib 8 extends through the slot.

In the embodiment shown, the sheet stack 1 consists of steel sheets, which are identical to within their manufacturing tolerances. These annular steel sheets in each case have projections arranged equidistantly on their outer circumference, for example, 4 to 10 projections. In the example shown, half of the projections have the width of the ribs 8, while the other half of the projections have an increased width, namely the width of the pressure application surfaces 6.

To build up the sheet stack 1, the steel sheets are stacked in groups, where the sheets in one group lie against each other at the same angle of rotation, and adjacent groups are rotated through an angle of rotation relative to each other; in the example shown this is through 45°. The projections 9 of neighbouring groups are thereby offset with respect to each other, so that the pressure application surfaces 6 on the boundary between a first and a second group can be accessed by the brackets 3. ere the ribs 8 facilitate the correct arrangement of the groups with respect to each other. A group can consist of 4 to 25 sheets, for example.

As is shown in particular by FIG. 5, the edge of the carrier 4, around which the brackets 3 engage, can protrude in an axial direction. Radially inwards from its protruding edge, the carrier 4 then has an axial recess 12, with which the relevant bracket 3 engages. To improve further the grip of the brackets 3, a spring tab 13 can be cut out of an end section of the brackets 3, for example, with a U-shaped line of cut. The spring tab 13 is pressed inwards, that is to say, towards the carrier 4, from the end section. The free end of the spring tab 13 faces towards the edge of the carrier 4 that protrudes in the axial direction. The spring tab 13 thus forms a hook that counteracts any detachment of the bracket 3.

To assemble the rotor, the sheet stack 1 is inserted into the carrier 4. The carrier 4 then abuts against the outer face of the stack 1, and has slots that extend in an axial direction, in which the ribs 8 and the projections 9 of the sheet stack 1 are arranged. In order to make it easier to insert the sheet stack 1 into the carrier 4, these slots of the carrier 4 can narrow towards the hub 5.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SYMBOLS

1 Sheet stack
2 Permanent magnets
3 Bracket
4 Carrier
5 Hub
6 Pressure application surface
8 Rib
9 Projection
10 Slot
11 Undercut
12 Axial recess
13 Spring tab

What is claimed is:

1. A rotor for an external rotor motor, comprising:
an annular stack of steel sheets welded together;
permanent magnets attached to an inner face of the stack;
a carrier comprising a hub for a shaft; and
brackets, which grip around a radially outer edge of the carrier and press the carrier against the stack in its direction;
wherein the stack has pressure application surfaces between its axial ends, against which presses one end of the brackets, which faces away from the hub.

2. The rotor according to claim 1, wherein the pressure application surfaces are surfaces of radial projections of the stack.

3. The rotor according to claim 2, wherein the projections have an undercut in their lateral surfaces extending in the axial direction, and the brackets engage with the undercut.

4. The rotor according to claim 2, wherein the carrier abuts against the outer face of the stack and has slots running in the axial direction in which the projections of the stack are arranged.

5. The rotor according to claim 1, wherein the stack is assembled from steel sheets of identical design, wherein a first group of consecutive sheets in the stacking direction is offset through an angle of rotation relative to a second group of consecutive sheets in the stacking direction, and the pressure application surfaces are thereby formed on the boundary between these two groups.

6. The rotor according to claim 1, wherein the carrier has an axial recess in the axial direction on its radially outer edge, around which the brackets engage, and the brackets engage with this axial recess.

7. The rotor according to claim 6, wherein a spring tab is cut out of an end section of the brackets, the free end of which tab faces towards the radially outer edge of the carrier.

8. The rotor according to claim 1, wherein the stack has ribs extending linearly in the axial direction on a radial outer surface, and the pressure application surfaces extend in the circumferential direction from the ribs.

9. The rotor according to claim 8, wherein the brackets have a slot in their end that presses against the pressure application surfaces, which slot one of the ribs engages.

10. The rotor according to claim 1, wherein the brackets are materially bonded to the stack.
